(19) United States
(12) Patent Application Publication
(10) Pub. No.: US 2017/0032412 A1
(43) Pub. Date: Feb. 2, 2017

(54) METHODS AND SYSTEMS FOR PREVENTING ADVERTISEMENTS FROM BEING DELIVERED TO UNTRUSTWORTHY CLIENT DEVICES

(71) Applicant: Vidscale Services, Inc., Cambridge, MA (US)

(72) Inventors: John Scharber, Placerville, CA (US); Richard Pugh, Phoenix, AZ (US)

(21) Appl. No.: 14/811,319

(22) Filed: Jul. 28, 2015

(51) Int. Cl. G06Q 30/02; H04L 29/06; G06F 17/30; H04L 29/08

(52) U.S. Cl. CPC G06Q 30/0248; H04L 67/28; H04L 67/42; G06F 17/30525

(57) ABSTRACT

Described herein are techniques to combat ad fraud, in which a client device is determined to be trustworthy or not trustworthy, and ads from an ad server are only provided to a client device that is determined to be trustworthy. As a result, client devices that have been infected with malware and ordinarily would have performed various forms of ad fraud (e.g., ad stacking, click fraud) receive no ads and are precluded from performing ad fraud. A proxy device within an ISP network may monitor all network traffic to and from the client device. Information useful in determining the trustworthiness of client device may be collected from the proxy device by an analysis server, which may use various indicators of trust in order to ascertain the trustworthiness of the client device.

### FIELD OF THE INVENTION

The present invention relates to managing the delivery of advertisements from an ad server to a client device, and more particularly relates to techniques for determining whether client devices are trustworthy so that advertisements can be delivered to only those client devices determined to be trustworthy.

### BACKGROUND

Today, the Internet is an integral part of many people's lives. Whether delivering news, sports, weather, e-mail, movies or other content, the Internet allows users of client devices (e.g., Internet connected phones, Internet connected tablet devices, Internet connected laptops, Internet connected desktops, etc.) to access almost any information that they desire, and in many instances free of charge. In exchange for the free access to content, users are expected to view advertisements (hereinafter, “ads”) that are typically displayed with the requested content. When advertisements are displayed (e.g., on a website, prior to a YouTube™ video, etc.), advertisers may pay content providers (e.g., individuals and/or companies that provide content) for the opportunity to place their ads in the content provided by the content providers.

More precisely, payment to content providers is typically made in return for an “ad impression” or an “impression” in short. An impression may include one or more of the following events: an ad being requested from an ad server (e.g., a server which sources ads), an ad being provided by an ad server, an ad being displayed on a browser of a client device and/or a user selecting (or “clicking”) an ad to access more information about the ad.

Not surprisingly, various parties have devised schemes to exploit the ad driven Internet ecosystem. For example, in click fraud, ads are clicked by computer programs (e.g., “bots”) attempting to simulate the online behavior of users. An advertiser may be deceived into paying for an impression, when in fact their ad was never viewed and/or clicked by a user. As another example, an advertiser's ad may be “displayed”, but not in a manner that was viewable and/or comprehensible to the user. The ad may be displayed for a split second, displayed under other ads (in a scheme known as “ad stacking” in which a group of ads are all displayed in a single ad slot and only the top ad is viewable), displayed outside the viewable area of the browser window, displayed in a miniature size, etc. Again, an advertiser may be deceived into paying for an impression, when in fact their ad was never viewed by a user, or even if viewed, not viewed in a manner enabling the user to comprehend the information present in the ad. In a syndicate referral type of ad fraud, an advertiser's ad may be displayed and viewed by users, but not on the website that the advertiser had requested. For example, instead of being displayed on cnn(dot)com, as an advertiser had requested, an ad may be displayed on xyz(dot)com.

In an attempt to combat various types of ad fraud, various solutions have been proposed and implemented. The existing solutions typically fall into one of two categories. In the first category, tools are provided to ensure a “pristine network” (i.e., a network void of malware and attackers). In many cases, ad fraud is the result of malware being installed on the various devices along the connection from (and including) the client device to the ad server. For example, “bots” performing click fraud may be the result of malware (e.g., a rootkit) being installed on a client device. Tools in the first category seek to either prevent the malware from being installed, or in the event that the malware is installed, seek to uninstall the malware. Antivirus software is one example of a tool in the first category. In the second category, tracking tools are used to monitor the delivery of ads to a client device in order to provide advertisers with an assurance that their ads have been delivered and viewed in a manner the advertisers intended. Based on data gathered by the tracking tools, fraudulent impressions are filtered from legitimate impressions. While such tools do have merit, reducing the amount and/or limiting the negative effects of ad fraud, they fall short of sufficiently addressing the increasingly sophisticated schemes devised by attackers.

### SUMMARY OF THE INVENTION

In accordance with one embodiment of the invention, a proxy is installed on an Internet service provider (ISP) network, allowing the proxy to monitor most (or all) of the traffic (e.g., data packets) to and from a client device. In addition to such data from the proxy, an analysis server may aggregate other data from the ISP network (e.g., from an ISP core of the ISP network) and data from the content provider into a datastore and analyze the data to determine the trustworthiness of one or more client devices connected to the Internet through the ISP network. Many indicators of trust may be employed, with less computationally intensive indicators (e.g., radix IP address lookups) employed before more computationally intensive indicators (e.g., string comparatives), if at all. For example, a client device that is suspected of committing ad fraud (e.g., click fraud, ad stacking, etc.) and/or infected with malware (e.g., a rootkit) may be determined not to be trustworthy. In addition, the trustworthiness of various other components (e.g., a proxy, a content provider) may be determined by the analysis server in a manner similar to the determination of the trustworthiness of the client devices.

In accordance with one embodiment of the invention, the proxy may intercept a request (e.g., an HTTP request) from a client device, the request requesting content from a content provider. In response to the client device's request, the proxy may transmit a request to the content provider, the request requesting content on behalf of the client device. The proxy may then receive the content from the content provider. The content may comprise one or more ad tags that indicate where, when and/or how an ad is to be inserted into the content and/or what type of ad is to be inserted into the content. In response to each of the ad tags, the proxy may request an ad from the ad server. To allow the ad server to decide whether to fulfill (and how to fulfill) the proxy's request for one or more ads, the proxy's request may include various information, such as an IP address of the client device (which has requested the content), a URL from which the content was retrieved, and/or behavioral information regarding the user of the client device.

In one embodiment of the invention, based on the IP address (or other identifier) of the client device, the ad server may determine whether the client device is trustworthy and accordingly, whether to provide an ad to the proxy. More specifically, the ad server may send a query to the analysis server to inquire whether the client device is trustworthy. If the client device is determined to be trustworthy, an ad may be provided by the ad server in response to the proxy's request for an ad. If, however, the client device is determined to not be trustworthy, the proxy's request for an ad may be rejected and no ad may be provided in response to the proxy's request for an ad. In the event that an ad is to be provided, the ad server may select which ad to provide based on the URL of the content (e.g., allowing the ad to target the content) and/or behavioral information regarding the user of the client device (e.g., allowing the ad to target the user). If the ad server provides an ad to the proxy, the proxy may insert the ad into the content requested by the client device and transmit the content with the ad inserted therein to the client device. If no ad is received by the proxy, the proxy may transmit the content to the client device, but without the ad specified by the ad tag.

In other embodiments of the invention, the ad server may also consider whether the proxy and/or content provider are trustworthy before providing an ad to the proxy. If the proxy and/or content provider are not trustworthy, no ad may be provided from the ad server to the proxy.

At this point, one may appreciate how the instant ad fraud solution, in accordance with some embodiments of the invention, falls outside and/or is complementary to the two existing categories of ad fraud solutions. The instant ad fraud solution can operate irrespective of whether the network is pristine or not. If the network is pristine (e.g., the client, proxy and content provider are all determined to be trustworthy), an ad may be provided by the ad server to the proxy. If the network is not pristine (e.g., one or more of the client, proxy and content provider are determined to be untrustworthy), no ad may be provided by the ad server to the proxy. The instant ad fraud solution in some respects is complementary to the first category of ad fraud solutions. In the event that an antivirus software determines that a client device has been infected with malware, the instant ad fraud solution can leverage this determination of the antivirus software and not deliver ads to the infected client device.

The instant ad fraud solution is likewise complementary to the second category of ad fraud solutions that monitor the delivery of ads, and based on the monitored data, filter impressions into legitimate and fraudulent impressions. The instant ad fraud solution may aggregate any information that the second category of ad fraud solutions provides as to whether a client device is trustworthy (e.g., any client device that generates fraudulent impressions may be considered to be untrustworthy) with other indicators of trust. The instant ad fraud solution in some respects makes the second category of ad fraud solutions more efficient. By only sending ads to those client devices that are considered trustworthy, the volume of fraudulent impressions is reduced, which reduces the workload of a process filtering legitimate impressions from fraudulent impressions. It is noted that under the instant ad fraud solution, it is not expected that the number of fraudulent impressions will be eliminated completely, as even some client devices that are deemed trustworthy might in fact be infected with malware.

These and other embodiments of the invention are more fully described in association with the drawings below.

### BRIEF DESCRIPTION OF THE DRAWINGS

FIG. 1 depicts the interconnections between an Internet service provider (ISP) network, client device, peer ISP network, content provider, ad server, analysis server, third-party analysis server, and domain name service (DNS) server, in accordance with one embodiment of the invention.

FIG. 2 depicts a flow diagram of a process performed by a proxy to deliver content with (or without) ads to a client device, in accordance with one embodiment of the invention.

FIG. 3 depicts a flow diagram of a process performed by an ad server in response to receiving a request for an ad, in accordance with one embodiment of the invention.

FIG. 4 depicts a sequence diagram of a process performed by a client device, proxy and ad server to monitor the delivery of ads to the client device, in accordance with one embodiment of the invention.

FIG. 5 depicts a sequence diagram of a process performed by a client device, proxy and ad server to thwart the operation of malware on the client device, in accordance with one embodiment of the invention.

FIG. 6 depicts a flow diagram of a process performed by a proxy to deliver content with (or without) ads to a client device, in accordance with one embodiment of the invention.

FIG. 7 depicts a flow diagram of a process performed by an ad server in response to receiving a request for an ad, in accordance with one embodiment of the invention.

FIG. 8 depicts a flow diagram of a process performed by an origin server in response to receiving a request for content, in accordance with one embodiment of the invention.

FIG. 9 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Description associated with any one of the figures may be applied to a different figure containing like or similar components/steps. While the flow diagrams each present a series of steps in a certain order, the order of the steps may be changed.

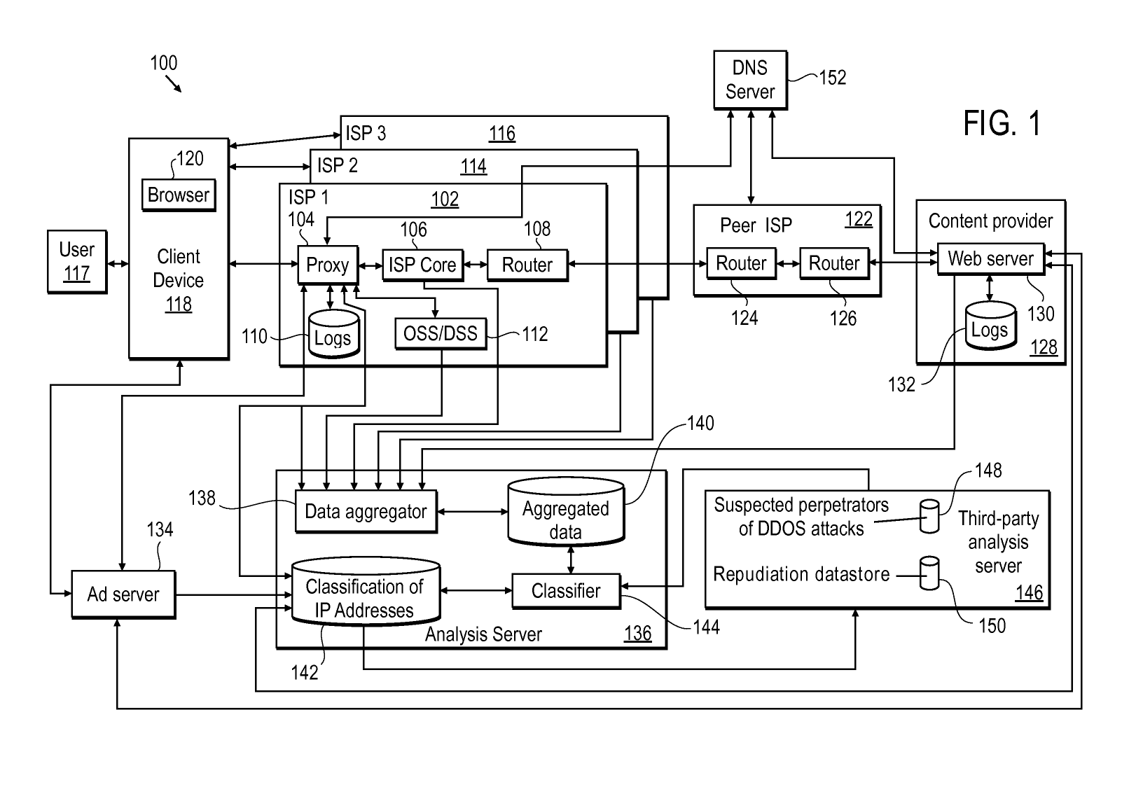

As depicted in network 100 of FIG. 1, proxy 104 may be present within first Internet service provider (ISP) network 102 (labeled as ISP 1 in FIG. 1). As is known in the art, an ISP network is a network provided by an ISP that connects one or more client devices to the Internet. Examples of ISPs are AT&T™ of Dallas, Tex.; Vodafone Group Plc™ of Newbury, UK; Comcast Corp.™ of Philadelphia, Pa.; and Ericsson™ of Stockholm, Stockholm County. Typically (but not always), users of the client devices are required to pay a subscription fee to the ISP in order to access the ISP network, and hence, users may be called “subscribers” in the context of an ISP network. An ISP network may include wired connections (e.g., copper wires, optical fibers), as well as wireless connections (e.g., cellular, satellite, Wi-Fi connections).

Proxy 104 may function as an intermediary device between client device 118 and ISP core 106. As described in more detail below, proxy 104 may intercept traffic (e.g., data packets) flowing from client device 118 to ISP core 106 and/or from ISP core 106 to client device 118.

Client device 118 may include an Internet connected phone, an Internet connected tablet device, an Internet connected laptop, an Internet connected desktop, etc. Instantiated on client device 118 may be web browser 120 (hereinafter, “browser”) that assists user 117 of client device 118 to retrieve and display content from the Internet.

ISP core 106 may comprise a long-distance (or long-haul) network that communicatively couples routers and/or proxies located in one city (or geographical area) with routers and/or proxies located in another city (or other geographical area). At the edge of ISP network 102 may be router 108 that communicatively couples ISP network 102 with peer ISP network 122. Peer ISP network 122 may include one more routers (e.g., 124 and 126). Router 124 may communicatively couple peer ISP network 122 to ISP network 102, whereas router 126 may communicatively couple peer ISP network 122 to content provider 128.

Content provider 128 may comprise web server 130 that services one or more requests for content. Another name for content provider 128 may be an “origin server” or “origin” in short. Examples of content providers include Netflix, Inc.™ of Los Gatos, Calif.; Amazon.com, Inc.™, of Seattle, Wash.; CBS™ of New York City, N.Y.; The Walt Disney Company™ of Burbank, Calif.; and YouTube™ of San Bruno, Calif.

Domain Name System (DNS) server 152 may assist proxy 104, peer ISP network 122, web server 130 and other devices (not depicted) to connect with one another. As is known in the art, a DNS server may translate a domain name into an IP address.

It is noted that the network topology depicted in FIG. 1 is exemplary in nature, and a greater or fewer number of routers/devices may be present in the network topology to communicatively couple proxy 104 with content provider 128. Further, while only a single client device and a single content provider are depicted in FIG. 1 for ease of illustration, numerous other client devices and content providers may be present in practice.

In accordance with one embodiment of the invention, analysis server 136 may aggregate data from various devices in network 100 in order to determine whether one or more of the devices therein (e.g., client 118, proxy 104, content provider 128) and/or users are trustworthy or untrustworthy. For example, a device that has been infected with malware may be determined to be untrustworthy, as well as a device that is operated by an attacker (e.g., a human which seeks to maliciously utilize the resources of the Internet at the detriment of other users).

Analysis server 136 may collect data from proxy 104, including logs (e.g., from log database 110) and metadata. For example, logs may record information associated with requests for content (e.g., IP address of source, IP address of destination, time of request, information requested, transmission protocol, etc.). Logs may also record information associated with the requested content (e.g., IP address of source, IP address of destination, time of transmittal, type of requested content, transmission protocol, etc.) For example, metadata may record the location in a webpage at which an ad was displayed, whether an ad was displayed in a visible location, how long an ad was displayed, etc.

Within ISP network 102 may be an operational support system (OSS) and/or a decision support system (DSS), depicted as OSS/DSS module 112 in FIG. 1. The OSS may monitor and analyze the traffic intercepted by proxy 104 and determine whether client device 118 has been infected by malware. For example, intercepted traffic that indicates client device 118 running exceptionally high loads and/or rates (as compared to other client devices) may indicate that client device 118 is infected. Likewise, intercepted traffic that indicates client device 118 driving traffic during off-peak hours may indicate that client device 118 is infected. As another example, intercepted traffic may reveal a command and control channel present between client device 118 and a server (not depicted). The presence of such a command and control channel may indicate that the client device 118 is being maliciously controlled by the server, in which case client device 118 may be known as a “bot” and the server may be known as a “bot herder”. The OSS may be the user interface through which a network support team interacts with proxy 104. In contrast, the DSS may perform data mining, perform data analytics and make decisions in response to the analysis of the data.

Analysis server 136 may also collect data from ISP core 106, such as network utilization (e.g., whether there are spikes in network traffic, and if so, when these spikes occur, etc.) For example, by employing a location analysis on the network traffic, analysis server 136 may determine whether client device 118 was used in a location outside of its typical area, and if so, may classify client device 118 as untrustworthy. By employing a temporal analysis on the network traffic, analysis server 136 may determine whether client device 118 was operated at an “atypical time” of the day (e.g., operated at 2 AM, a time at which the user of client device 118 is typically asleep), and if so, may classify client device 118 as untrustworthy. As another example, the network traffic collected from ISP core 106 may also reveal the frequency of HTTP post requests. If the HTTP post requests are very frequent, such data pattern may indicate that client device 118 is not being operated by a human. More generally, analysis server 136 may employ pattern analysis on the network traffic collected from ISP core 106 in order to detect deviations from nominal behavior, and/or detect behavior indicative of client device 118 being operated by a bot.

Analysis server 128 may also collect data from web server 130, including logs stored in logs database 132 of content provider 128. By correlating logs from content provider 128 and logs from proxy 104, certain patterns in the network traffic may become more apparent than if logs from only one device were analyzed.

Analysis server 136 may also collect data from other ISP networks (e.g., ISP network 114 and ISP network 116) used by client device 118. The internal components of ISP network 114 and ISP network 116 may be similar to that of ISP network 102, and hence, are not depicted for ease of illustration. For example, ISP network 102 may represent client device 118 being connected to a cellular network; ISP network 114 may represent client device 118 being connected to a WiFi network; and ISP network 116 may represent client device 118 being connected to a cellular network when the client device is roaming (e.g., in a foreign country). By correlating data from multiple ISP networks, certain patterns in the network traffic may become more apparent than if data from a single ISP network were analyzed.

In one embodiment of the invention, analysis server 136 may include a data aggregator module 138 which aggregates data (e.g., logs, metadata, estimated likelihood that a device has been infected by malware) from various devices in network 100, and stores the aggregated data in datastore 140. The aggregated data may be analyzed by classifier module 144 which seeks to determine the trustworthiness of one or more devices (and/or users) in network 100. Classifier module 144 may apply a series of progressively more complex classifiers. For example, classifier module 144 may first determine whether a device (as identified by its IP address) has already been classified. If so (and if the associated classification has been made with a high confidence), no further classification may be performed by classifier module 144 on the device. If, however, no previous classification of the device exists (or if the classification of the device has been made with low confidence), classifier module 144 may perform additional analysis (e.g., correlation analysis, string comparatives) in order to determine whether a device should be trusted. The classification of a device by classifier module 144 may be logically combined with pre-existing classification(s) associated with the same device (pre-existing classification(s) stored in datastore 142) to form a refined classification of the device (i.e., that has a higher likelihood of being a correct classification). A determination of whether one or more devices and/or users should be trusted may be stored in datastore 142.

In one embodiment of the invention, classifier module 144 may determine a likelihood that client device 118 has been infected by malware. In response to determining a high likelihood that client device 118 has been infected by malware, classifier module 144 may determine that client device 118 is not trustworthy. In another embodiment of the invention, classifier module 144 may determine a likelihood that client device 118 is controlled by a bot herder. In response to determining a high likelihood that client device 118 is controlled by a bot herder, classifier module 144 may determine that client device 118 is not trustworthy.

It is noted that the trustworthiness classification of one or more devices and/or users may be a binary classification (i.e., trustworthy, not trustworthy) or could be a more granular classification (e.g., very trustworthy, somewhat trustworthy, somewhat untrustworthy, and very untrustworthy). The trustworthiness classification could also employ a numerical classification scheme (e.g., trustworthiness value ranging from 1, 2, 3 and 4, with 1 indicating very trustworthy, 2 indicating somewhat trustworthy, 3 indicating somewhat untrustworthy and 4 indicating very untrustworthy).

In addition, classifier module 144 may take as input one or more classifiers provided by third-party analysis server 146. For example, third-party analysis server 146 may include datastore 148 which stores IP addresses of suspected perpetrators of distributed denial-of-service (DDoS) attacks and/or a repudiation datastore 150 (e.g., blacklist of IP addresses of devices known to be malicious), and information from datastores 148 and 150 may be provided to classifier module 144. Classifier module 144 may logically combine such third-party classification information with classification information internally generated by analysis server 136 in order to arrive at a more refined classification of one or more devices in network 100. In turn, such classifications from datastore 142 may be provided back to third-party analysis server 146 (e.g., in a feedback scheme) to aid third-party analysis server 146 in its classification operations.

The classification information generated by analysis server 136 may be used to thwart ad fraud, as further described below. In one embodiment of the invention, proxy 104 may intercept a request (e.g., an HTTP request) from client device 118 for content from content provider 128. In response to the client device's request, proxy 104 may transmit a request to content provider 128, requesting content on behalf of client device 118. Proxy 104 may then receive the requested content from content provider 128. The content may comprise one or more ad tags that indicate where, when and/or how an ad is to be inserted into the content and/or what type of advertisement is to be inserted into the content. In response to each of the ad tags, proxy 104 may request an ad from ad server 134. To allow ad server 134 to decide whether to fulfill (and how to fulfill) the proxy's request for one or more ads, the proxy's request may include various information, such as an Internet protocol (IP) address of client device 118 (which has requested the content), a hardware identifier of client device 118, a media access control (MAC) address of client device 118, a user name of user 117, a user password of user 117, a URL from which the content was retrieved, and/or behavioral information regarding the user of client device 118.

In one embodiment of the invention, based on the IP address (or other identifier) of client device 118, ad server 134 may determine whether client device 118 is trustworthy and accordingly, whether to provide an ad to proxy 104. More specifically, ad server 134 may send a query to analysis server 136 to inquire whether client device 118 is trustworthy. If client device 118 is determined to be trustworthy, an ad may be provided by ad server 134 in response to the proxy's request for an ad. If, however, client device 118 is determined not to be trustworthy, the proxy's request for an ad may be rejected and no ad may be provided in response to the proxy's request for an ad. In the event that an ad is to be provided, ad server 134 may select which ad to provide based on the URL of the content (e.g., allowing the ad to target the content) and/or behavioral information regarding the user of client device 118 (e.g., allowing the ad to target the user). Further, the selection of an ad may further be based on the trustworthiness of client device 118. For example, a high value ad (e.g., an ad that has a high cost-per-click) may be selected for a trustworthy client device, while a lower value ad (e.g., an ad that has a lower cost-per-click) may be selected for a less trustworthy client device.

In one embodiment of the invention, the behavioral information regarding the user of client device 118 may be captured in a video ad serving template (VAST) cookie. Such VAST cookie may be generated by proxy 104 based on subscriber information stored in a subscriber database of OSS/DSS module 112 (e.g., proxy 104 may translate the subscriber information into a VAST cookie). The subscriber information available in ISP network 102 may typically contain more detailed information about the user than user information that can be inferred from cookies stored on client device 118. For example, the subscriber information may contain a record of when usage occurred, the user's profile information, an address of the user, hours that the user is available, what type of content was requested, data usage patterns, the location of the user and demographic information of the user, whereas such information may not be readily available from cookies on client device 118. Nevertheless, the subscriber information utilized to generate a VAST cookie may be less specific than that available in the subscriber database of OSS/DSS module 112 in order to protect the user's privacy. For example, instead of relying upon the exact location of a user, the VAST cookie generated by proxy 104 could rely upon the city in which the user is located. An advantage offered by exposing subscriber information externally (i.e., outside of ISP network 102) is that an ad broker (such as DoubleClick™, a subsidiary of Google Inc.™ of Mountain View, Calif.) will have access to the subscriber information of ISP network 102. Stated differently, exposing the subscriber information externally might allow ISPs to monetize content that the ISPs would otherwise not have the ability to monetize (e.g., over-the-top content).

If ad server 134 provides an ad to proxy 104, proxy 104 may insert the ad into the content requested by client device 118 and transmit the content with the ad inserted therein to client device 118. If, however, no ad is received by proxy 104, proxy 104 may transmit the content to client device 118, but without the ad specified by the ad tag. In some embodiments of the invention, ad server 134 may also consider whether proxy 104 and/or content provider 128 are trustworthy before providing an ad to proxy 104. If proxy 104 and/or content provider 128 are not trustworthy, no ad may be provided from ad server 134 to proxy 104.

In one embodiment of the invention, ads may be “pre-resolved” at proxy 104 before being transmitted to client device 118. In pre-resolving an ad, a binary of an ad may be inserted into content (e.g., an HTML and/or XML file) at locations marked by ad tags. Delivering content with pre-resolved (or “pre-stitched”) ads to client device 118 may reduce the amount of time required for the content and ads to load on browser 120 of client 118 (as compared to the scenario in which browser 120 directly requests ads from ad server 134). By reducing the loading time, a Quality of Experience (QoE) of a user of client device 118 may be increased.

In one embodiment of the invention, an ad may be inserted into content in a specific manner by proxy 104 for computational efficiency. First, proxy device 104 may determine, based on characteristics of the client device 118 and/or the bandwidth of the communication channel between client device 118 and proxy 104, a bit rate suitable for client device 118. Based on the determined bit rate, proxy 104 may select a version of a mezzanine file corresponding to the determined bit rate (a mezzanine file being a specific type of a file storing content). After receiving an ad from ad server 134, the ad may be inserted into the selected version of the mezzanine file. Finally, the selected version of the mezzanine file with the ad inserted therein may be transmuxed into a format that is suitable for playback by client device 118. In another embodiment, the above procedure for inserting ads into content may be applied to an MPEG-4 fragment file, instead of a mezzanine file (an MPEG-4 fragment file also being a specific type of a file storing content). The computational efficiency is achieved by performing the transmuxing operation after the ad insertion operation, as compared to trasmuxing the content and the ad separately, and then inserting the transmuxed ad into the transmuxed content. In accordance with one embodiment of the invention, a single transmuxing operation may be needed in order to deliver the content with ads, as compared to two (or more) transmuxing operations in prior content delivery techniques in which content and ad(s) are transmuxed separately from one another.

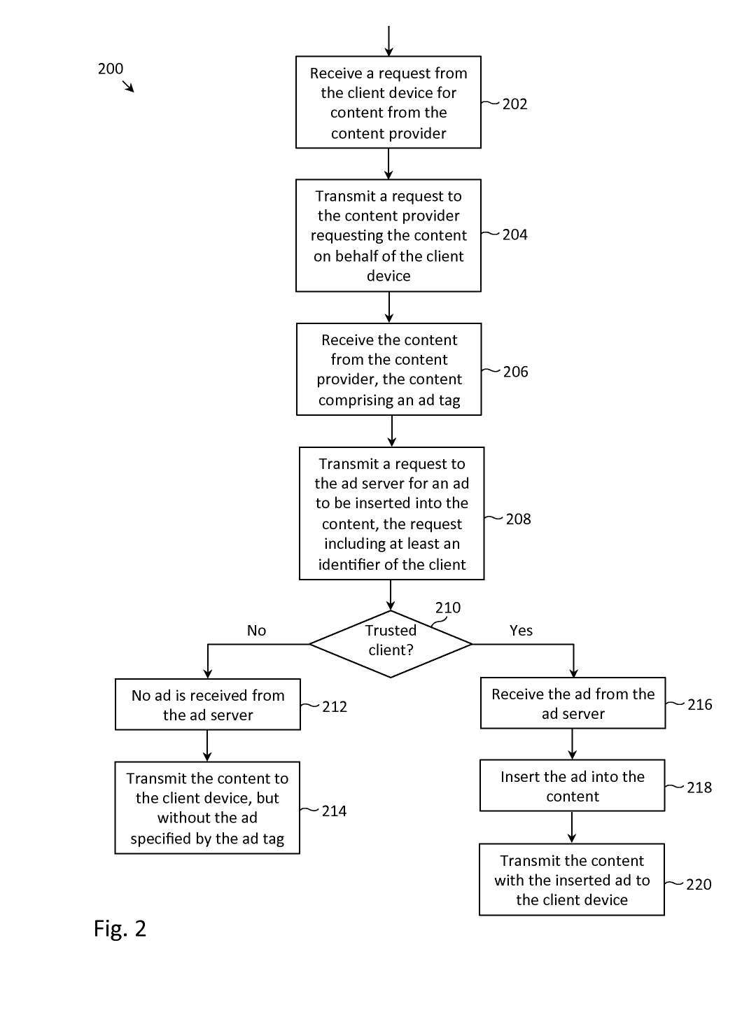

Flow diagrams and sequence diagrams are now presented to more fully describe the processes described above. FIG. 2 depicts flow diagram 200 of a process performed by proxy 104 to deliver content with (or without) ads to client device 118, in accordance with one embodiment of the invention. At step 202, proxy 104 may receive a request from client device 118 for content from content provider 128. At step 204, proxy 104 may transmit a request to content provider 128 requesting the content on behalf of client device 118. At step 206, proxy 104 may receive the content from content provider 128, the content comprising one or more ad tags. At step 208, proxy 104 may transmit a request to ad server 134 for an ad to be inserted into the content, the request including at least an identifier of the client(e.g., an IP address of client device 118, a hardware identifier of client device 118, a MAC address of client device 118, a user name of user 117, a password of user 117). If the client (e.g., user 117, user device 118) is determined to be trustworthy or sufficiently trustworthy (“Yes” branch of step 210), proxy 104 may receive an ad from ad server 134 (step 216), insert the ad into the content (step 218) and transmit the content with the inserted ad to client device 118 (step 220). If, however, the client is determined to not be trustworthy or not sufficiently trustworthy (“No” branch of step 210), no ad may be received by proxy 104 from ad server 134 (step 212) and proxy 104 may transmit the content to client device 118, but without the ad specified by the ad tag (step 214). For clarity, it is noted that step 210 is depicted in FIG. 2 to more clearly describe the decision branching in the process of FIG. 2. It is not required that step 210 (i.e., the determination of whether the client is trustworthy) actually be performed by proxy 104.

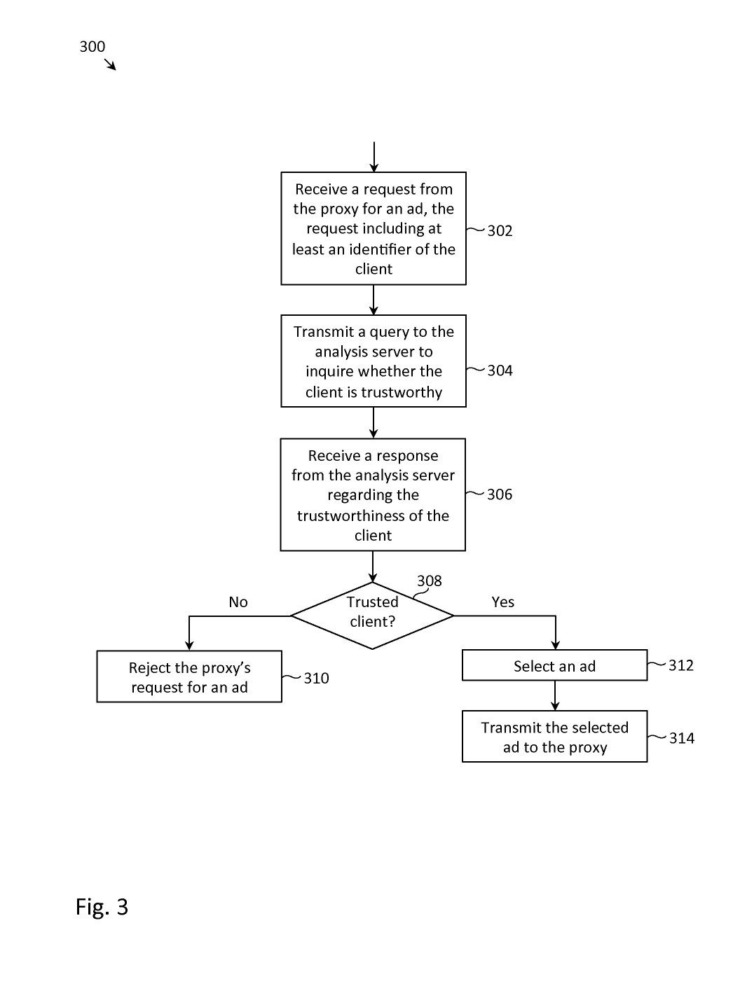

FIG. 3 depicts flow diagram 300 of a process performed by ad server 134 in response to receiving a request for an ad, in accordance with one embodiment of the invention. In step 302, ad server 134 may receive a request from proxy 104 for an ad, the request including at least the identifier of the client (e.g., an IP address of client device 118, a hardware identifier of client device 118, a MAC address of client device 118, a user name of user 117, a password of user 117). As mentioned above, the request may also include a URL of the content into which the ad is to be inserted and behavioral information of user 117. At step 304, ad server 134 may transmit a query to analysis server 136 to inquire whether the client (e.g., user 117 and/or client device 118) is trustworthy (and/or the trustworthiness of the client). At step 306, ad server 134 may receive a response from analysis server 136 regarding the trustworthiness of the client. If the client is determined to be trustworthy or sufficiently trustworthy, ad server 134 may select an ad based on one or more of the URL of the content, behavioral information of user 117 and other criteria (step 312), and transmit the selected ad to proxy 104 (step 314). Otherwise, ad server 134 may reject the proxy's request for an ad (step 310).

To expand upon step 312 above, ad server 134 may select an ad additionally based on the trustworthiness of the client. For example, if the client is determined to be very trustworthy, ad server 134 may select a high value ad (e.g., an ad that has a high cost-per-click). If, however, the client is determined to be only somewhat trustworthy, ad server 134 may select a lower value ad (e.g., an ad that has a lower cost-per-click).

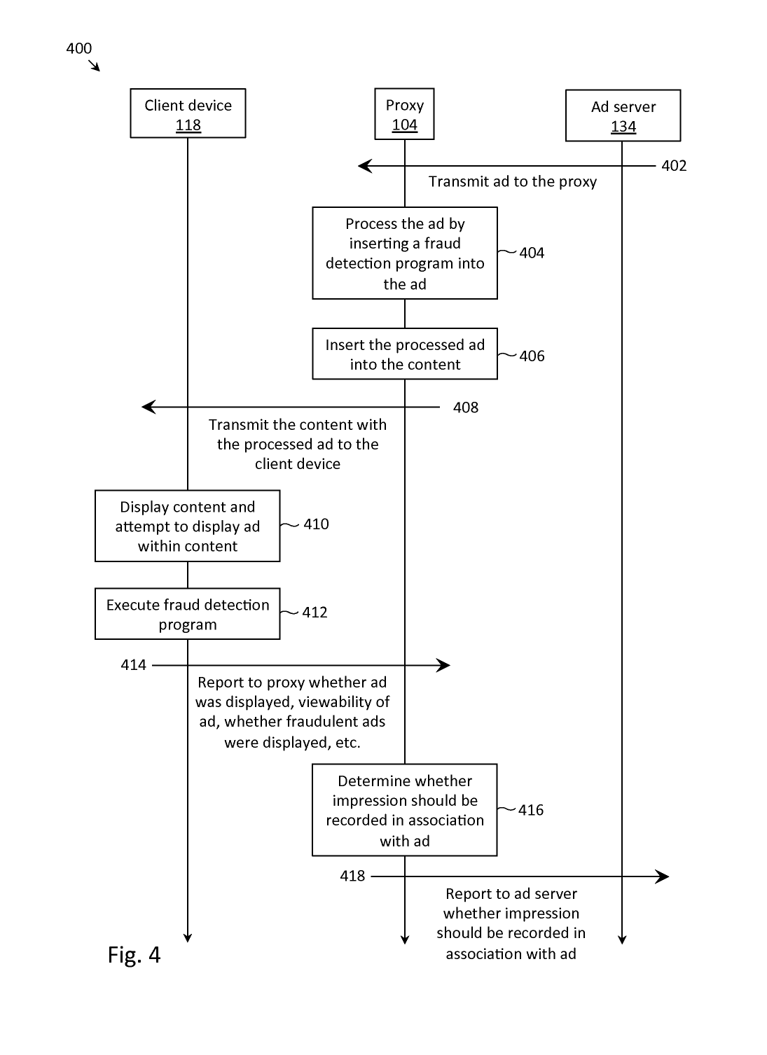

FIG. 4 depicts sequence diagram 400 of a process performed by client device 118, proxy 104 and ad server 134 to monitor the delivery of ads to client device 118, in accordance with one embodiment of the invention. It is noted that sequence diagram 400 provides additional details that may be performed in association with steps 216, 218 and 220 of FIG. 2, as well as steps that may be performed after step 220 of FIG. 2. At step 402, ad server 134 may transmit an ad to proxy 104. At step 404, proxy 104 may process the ad by inserting a fraud detection program (e.g., a JavaScript™ program) into the ad. At step 406, proxy 104 may insert the processed ad into the content. At step 408, proxy 104 may transmit the content (with the processed ad inserted therein) to client device 118. At step 410, client device 118 (e.g., more specifically, browser 120 of client device) may display the content and attempt to display the ad associated with the content. At step 412, the fraud detection program may be executed. At step 414, the fraud detection program may report to proxy 104 whether the ad was displayed, and if so, where the ad was displayed (e.g., the URL of the webpage, the URL of video, where in a webpage the ad was displayed), the viewability of the ad (e.g., how long the ad was displayed, the size of the displayed ad), whether any fraudulent ads were displayed, etc. At step 416, proxy 104 may determine whether an impression should be recorded in association with the ad. For example, if the fraud detection program reports that the ad was displayed for 10 seconds in an ad slot that is 30 by 70 pixels in size, and was clicked on by user 117, proxy 104 may determine that an impression should be recorded in association with the ad. If, however, the fraud detection program determines that the ad was hidden by, for example, an “ad stacking” scheme, proxy 104 may determine that no impression should be recorded in association with the ad. At step 418, proxy 104 may report to ad server 134 whether an impression should be recorded in association with the ad (a tracking beacon may be one example of such a report). While not depicted in FIG. 4, it is contemplated that the information reported by the fraud detection program to proxy 104 in step 414 may subsequently be collected and analyzed by analysis server 136 in order to determine whether client device 118 is trustworthy.

In one variation of the process described above in association with FIG. 4, an ad signature may be inserted into the ad (such ad signature being metadata associated with the ad) in addition to inserting a fraud detection program into the ad. In one embodiment, an ad signature may be generated by applying a hash function to the binary file of the ad. Upon detecting that an ad has been displayed at client device 118, the fraud detection program may determine whether the intended ad was displayed (e.g., ad served by ad server 134 was displayed) or whether a fraudulent ad was displayed (e.g., ad served by server other than ad server 134 was displayed) by analyzing the ad signature within the ad. If the signature has been tampered or is missing, the fraud detection program may determine that the displayed ad is fraudulent. More specifically, in one embodiment, the fraud detection program may compute a hash of the binary file of the ad and if the computed hash matches the signature inserted into the ad, the ad may be determined to be authentic (e.g., authentic meaning that the ad was served by ad server 134). In such a scheme, the hash function used by the fraud detection program and proxy 104 would be the same hash function.

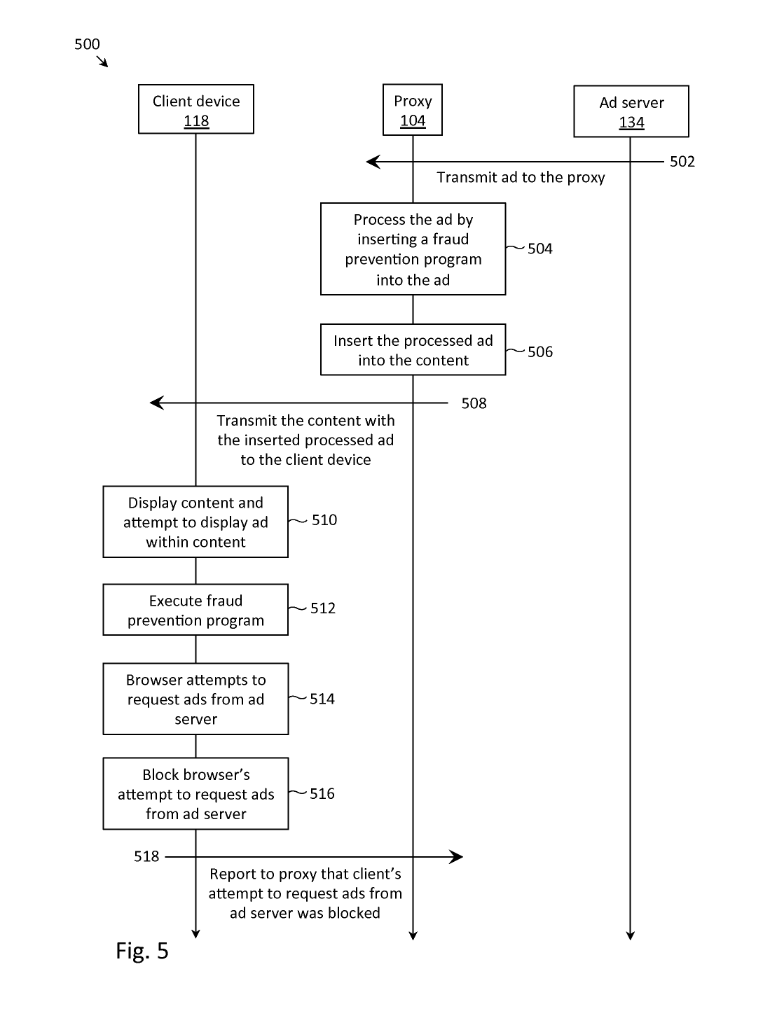

FIG. 5 depicts sequence diagram 500 of a process performed by client device 118, proxy 104 and ad server 134 to thwart the operation of malware on client device 118, in accordance with one embodiment of the invention. It is noted that sequence diagram 500 provides additional details that may be performed in association with steps 216, 218 and 220 of FIG. 2, as well as steps that may be performed after step 220 of FIG. 2. At step 502, ad server 134 may transmit an ad to proxy 104. At step 504, proxy 104 may process the ad by inserting a fraud prevention program (e.g., a JavaScript™ program) into the ad. At step 506, proxy 104 may insert the processed ad into the content. At step 508, proxy 104 may transmit the content (with the processed ad inserted therein) to client device 118. At step 510, client device 118 (e.g., more specifically, browser 120 of client device 118) may display the content and attempt to display the ad associated with the content. At step 512, the fraud prevention program may be executed. At step 514, browser 120 that has been infected with malware attempts to request ads from ad server 134 (or other ad server). At step 516, the fraud prevent program blocks any attempts by browser 120 to request ads from ad server 134 (or other ad server). If such attempts were not blocked, ads retrieved by browser 120 may be used maliciously by the malware (e.g., displayed over ads, displayed over content, etc.) At step 518, the fraud prevention program may report to proxy 104 any attempts by client device 118 to request ads from ad server 134 (or other ad server). To elaborate, the process of FIG. 5 describes a fraud prevention scheme that may be employed in the event that an ad is inadvertently delivered to an untrustworthy client device. Such process may provide a backup measure (e.g., to thwart the execution of ad fraud malware) in the event that the first line of defense (e.g., selectively delivering ads only to trustworthy client devices) has failed.

While the description associated with FIGS. 4 and 5 have described an ad fraud detection program and an ad fraud prevention program being transmitted to client device 118 using an ad as a delivery mechanism (i.e., vector), other techniques to transmit an ad fraud detection program and/or an ad fraud prevention program to client device 118 are possible. For example, ad fraud detection program and/or an ad fraud prevention program may be delivered to client device 118 as part of an update to the browser software and/or as part of an update to the operating system of client device 118.

In many of the embodiments described above, the determination of whether the client (e.g., user 117 and/or client device 118) is trustworthy or not is transmitted to ad server 134, and ad server 134 in turn makes a determination as to whether an ad is to be provided to proxy 104. In other embodiments of the invention, it is possible that the determination of whether the client is trustworthy or not is transmitted from analysis server 136 to proxy 104. Based on the determination, proxy 104 may determine whether to transmit a request to ad server 134 for an ad. For example, in response to determining that the client is not trustworthy, proxy 104 may determine that no ads are to be inserted into content requested by the client (which eliminates the step of requesting an ad from ad server 134 in the event that no ad is to be inserted). In yet other embodiments of the invention, it may be possible for proxy 104 to analyze the traffic intercepted between client device 118 and content provider 128 and independently determine whether the client is trustworthy (independent of the analysis performed by analysis server 136). Based on the determination by proxy 104 as to the trustworthiness of the client, proxy 104 may determine whether or not to insert ads into the content requested by the client.

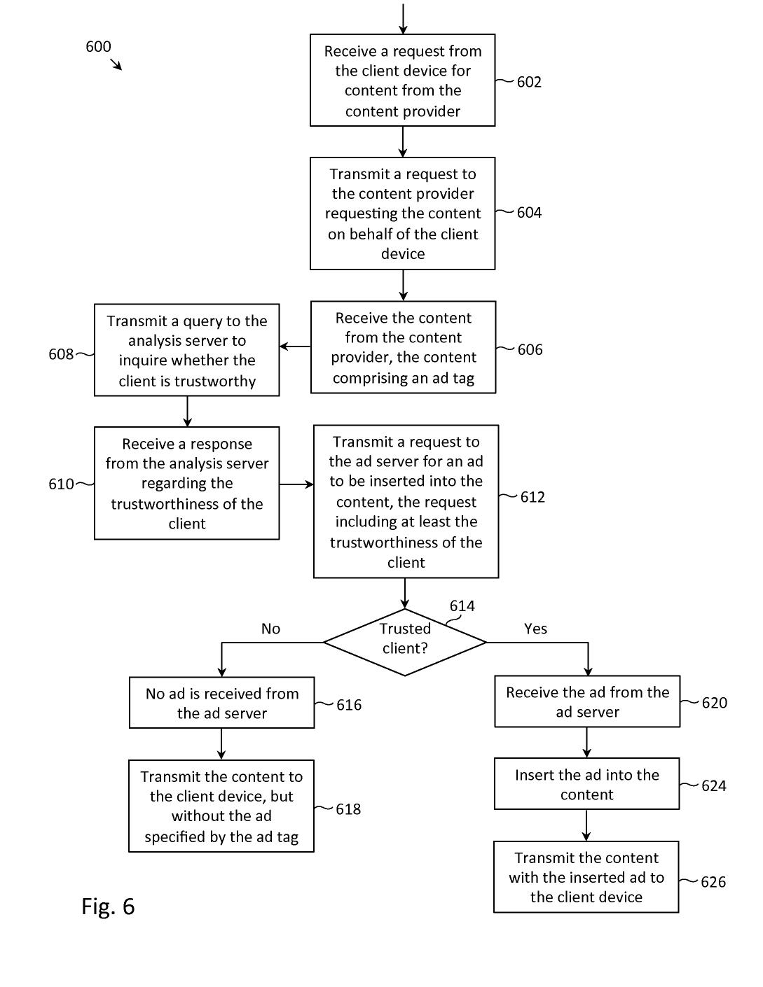

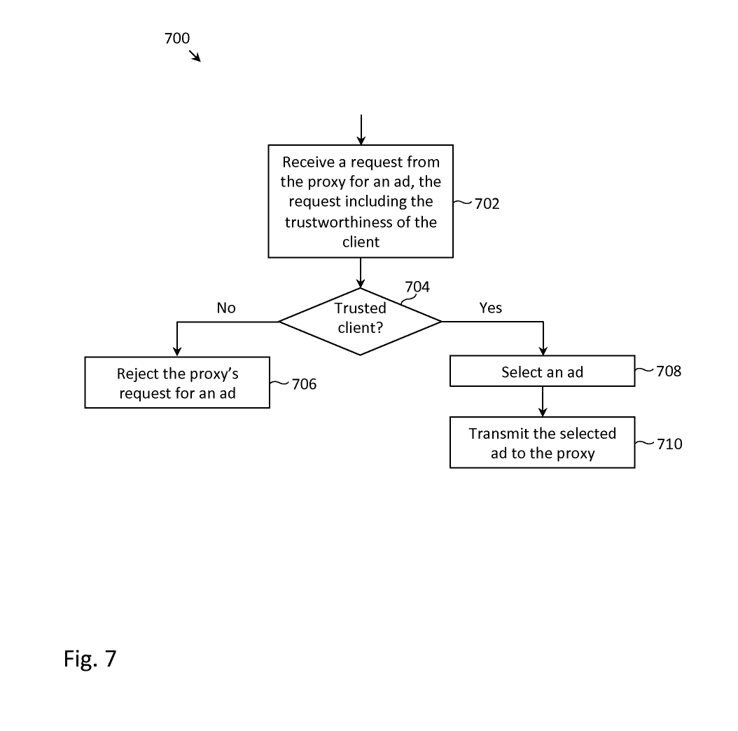

FIGS. 6 and 7 depict a variant of FIGS. 2 and 3, respectively. In short, the variant involves proxy 104 querying the trustworthiness of client device 118, instead of such querying performed by ad server 134. FIG. 6 depicts flow diagram 600 of a process performed by proxy 104 to deliver content with (or without) ads to client device 118, in accordance with one embodiment of the invention. At step 602, proxy 104 may receive a request from client device 118 for content from content provider 128. At step 604, proxy 104 may transmit a request to content provider 128 requesting the content on behalf of client device 118. At step 606, proxy 104 may receive the content from content provider 128, the content comprising one or more ad tags. At step 608, proxy 104 may transmit a query to analysis server 136 with an identifier of the client, the query inquiring from analysis server 136 whether the client (e.g., user 117 and/or client device 118) is trustworthy (and/or the trustworthiness of the client). At step 610, proxy 104 may receive a response from analysis server 136 regarding the trustworthiness of the client. At step 612, proxy 104 may transmit a request to ad server 134 for an ad to be inserted into the content, the request including at least the trustworthiness of the client. If the client is determined to be sufficiently trustworthy by ad server 134 (“Yes” branch of step 614), proxy 104 may receive an ad from ad server 134 (step 620), insert the ad into the content (step 624) and transmit the content with the inserted ad to client device 118 (step 626). If, however, the client is determined to not be sufficiently trustworthy by ad server 134 (“No” branch of step 614), no ad may be received by proxy 104 from ad server 134 (step 616) and proxy 104 may transmit the content to client device 118, but without the ad specified by the ad tag (step 618).

FIG. 7 depicts flow diagram 700 of process 700 performed by ad server 134 in response to receiving a request for an ad, in accordance with one embodiment of the invention. In step 702, ad server 134 may receive a request from proxy 104 for an ad, the request including at least the trustworthiness of the client. As mentioned above, the request may also include a URL of the content into which the ad is to be inserted and behavioral information of user 117. If ad server 134 considers the client to be trustworthy or sufficiently trustworthy, ad server 134 may select an ad based on one or more of the URL of the content, behavioral information of user 117 and other criteria (step 708), and transmit the selected ad to proxy 104 (step 710). Otherwise, ad server 134 may reject the proxy's request for an ad (step 706).

In the variant of FIGS. 6 and 7, the amount of processing at ad server 134 is reduced as ad server 134 no longer needs to retrieve the trustworthiness of the client from analysis server 136. If the retrieval of trustworthiness information by proxy 104 were faster than the retrieval of trustworthiness information by ad server 134, the embodiment described in FIGS. 6 and 7 could potentially reduce the time taken by proxy 104 to serve content with ads to client device 118 (as compared to the embodiment described in FIGS. 2 and 3).

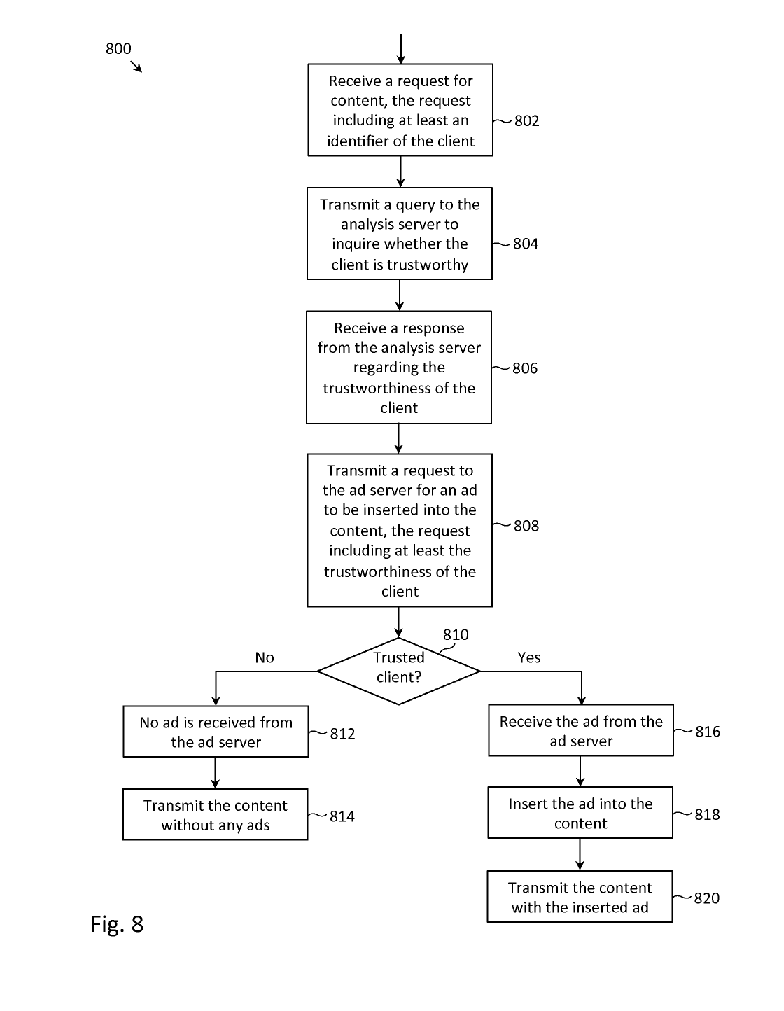

While the description so far has described ads being inserted at proxy 104, this is not necessarily so. In flow diagram 800 of FIG. 8, ads may be inserted at web server 130 (i.e., at “origin server”). At step 802, web server 130 may receive a request for content, the request including at least an identifier of the client. Such request may be indirectly received from proxy 104 (via peer ISP 122) or another component of network 100. At step 804, web server 130 may transmit a query to analysis server 136 with the identifier of the client, the query inquiring analysis server 136 whether the client is trustworthy (and/or the trustworthiness of the client). At step 806, web server 130 may receive a response from analysis server 136 regarding the trustworthiness of the client. At step 808, web server 130 may transmit a request to ad server 134 for an ad to be inserted into the content, the request including at least the trustworthiness of the client. If the client is determined to be sufficiently trustworthy by ad server 134 (“Yes” branch of step 810), web server 130 may receive an ad from ad server 134 (step 816), insert the ad into the content (step 818) and transmit the content with the inserted ad to proxy 104 (via peer ISP 122) or another component of network 100 (step 820). If, however, the client is determined to not be sufficiently trustworthy by ad server 134 (“No” branch of step 810), no ad may be received by web server 130 from ad server 134 (step 812) and web server 130 may transmit the content without any ads to proxy 104 (via peer ISP 122) or another component of network 100 (step 814).

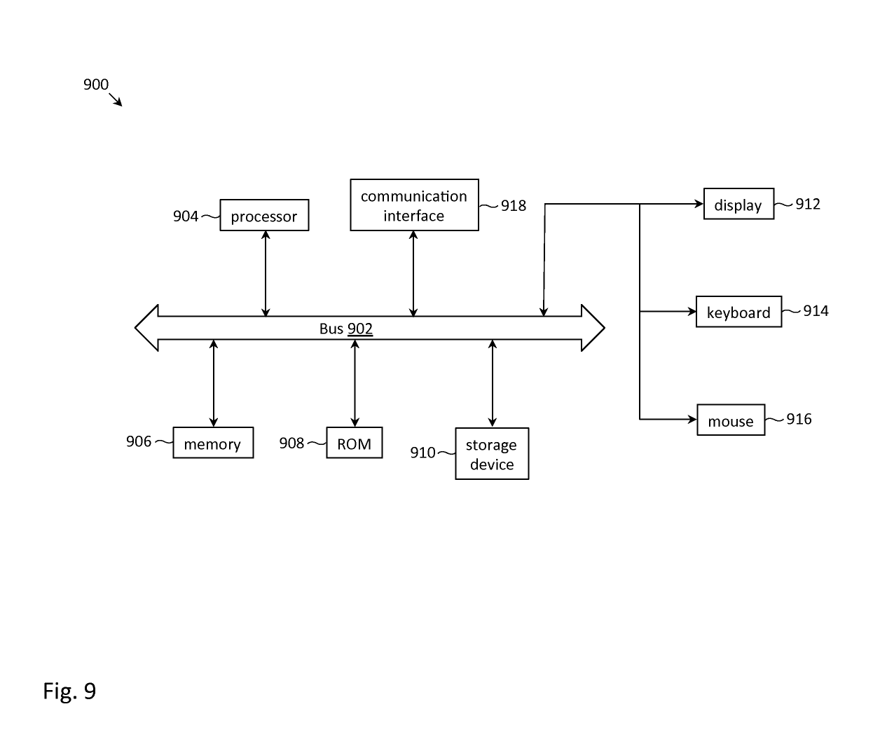

As is apparent from the foregoing discussion, aspects of the present invention involve the use of various computer systems and computer readable storage media having computer-readable instructions stored thereon. FIG. 9 provides an example of a system 900 that is representative of any of the computing systems discussed herein. Note, not all of the various computer systems have all of the features of system 900. For example, certain ones of the computer systems discussed above may not include a display inasmuch as the display function may be provided by a client computer communicatively coupled to the computer system or a display function may be unnecessary. Such details are not critical to the present invention.

System 900 includes a bus 902 or other communication mechanism for communicating information, and a processor 904 coupled with the bus 902 for processing information. Computer system 900 also includes a main memory 906, such as a random access memory (RAM) or other dynamic storage device, coupled to the bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to the bus 902 for storing static information and instructions for the processor 904. A storage device 910, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 904 can read, is provided and coupled to the bus 902 for storing information and instructions (e.g., operating systems, applications programs and the like).

Computer system 900 may be coupled via the bus 902 to a display 912, such as a flat panel display, for displaying information to a computer user. An input device 914, such as a keyboard including alphanumeric and other keys, may be coupled to the bus 902 for communicating information and command selections to the processor 904. Another type of user input device is cursor control device 916, such as a mouse, a trackball, or cursor direction keys for communicating direction information and command selections to processor 904 and for controlling cursor movement on the display 912. Other user interface devices, such as microphones, speakers, etc. are not shown in detail but may be involved with the receipt of user input and/or presentation of output.

The processes referred to herein may be implemented by processor 904 executing appropriate sequences of computer-readable instructions contained in main memory 906. Such instructions may be read into main memory 906 from another computer-readable medium, such as storage device 910, and execution of the sequences of instructions contained in the main memory 906 causes the processor 904 to perform the associated actions. In alternative embodiments, hard-wired circuitry or firmware-controlled processing units (e.g., field programmable gate arrays) may be used in place of or in combination with processor 904 and its associated computer software instructions to implement the invention. The computer-readable instructions may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 900 or similar electronic computing device, that manipulates and transforms data represented as physical (electronic) quantities within its registers and memories into other data similarly represented as physical quantities within its memories or registers or other such information storage, transmission or display devices.

Computer system 900 also includes a communication interface 918 coupled to the bus 902. Communication interface 918 may provide a two-way data communication channel with a computer network, which provides connectivity to and among the various computer systems discussed above. For example, communication interface 918 may be a local area network (LAN) card to provide a data communication connection to a compatible LAN, which itself is communicatively coupled to the Internet through one or more Internet service provider networks. The precise details of such communication paths are not critical to the present invention. What is important is that computer system 900 can send and receive messages and data through the communication interface 918 and in that way communicate with hosts accessible via the Internet.

It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for a proxy communicatively coupled to a client, an ad server and a content provider, the method comprising:
receiving at the proxy a first request from the client for content from the content provider;
in response to receiving the first request, transmitting by the proxy a second request to the content provider, the second request requesting the content on behalf of the client;
receiving the content at the proxy from the content provider, the content comprising an ad tag that provides specifications for an advertisement to be inserted into the content;
in response to detecting the ad tag, transmitting by the proxy a third request to the ad server for the advertisement to be inserted into the content, the third request including at least an identifier of the client;
if the ad server determines based on the client identifier that the client is trustworthy, (i) receiving at the proxy the advertisement from the ad server, (ii) inserting by the proxy the advertisement into the content, and (iii) transmitting from the proxy to the client the content with the advertisement inserted therein, the advertisement inserted in accordance with the ad tag; and
if the ad server determines based on the client identifier that the client is not trustworthy, (i) not receiving at the proxy the advertisement from the ad server, and (ii) transmitting from the proxy to the client the content, but without the advertisement specified by the ad tag.

2. The method of claim 1, wherein the proxy is located within a first Internet service provider (ISP) network.

3. The method of claim 2, wherein data from the first ISP network is collected by an analysis server in order for the analysis server to determine whether the client is trustworthy, and the ad server's determination of whether the client is trustworthy is based on the analysis server's determination of whether the client is trustworthy.

4. The method of claim 2, wherein data from the proxy of the first ISP network is collected by an analysis server in order for the analysis server to determine whether the client is trustworthy, and the ad server's determination of whether the client is trustworthy is based on the analysis server's determination of whether the client is trustworthy.

5. The method of claim 2, wherein data from an ISP core of the first ISP network is collected by an analysis server in order for the analysis server to determine whether the client is trustworthy, and the ad server's determination of whether the client is trustworthy is based on the analysis server's determination of whether the client is trustworthy.

6. The method of claim 2, wherein data from the first ISP network and a second ISP network is collected by an analysis server in order for the analysis server to determine whether the client is trustworthy, and the ad server's determination of whether the client is trustworthy is based on the analysis server's determination of whether the client is trustworthy.

7. The method of claim 3, wherein the client comprises a client device, and wherein the analysis server determines a likelihood that the client device has been infected by malware, and in response to determining a high likelihood that the client device has been infected by malware, determining that the client device is not trustworthy.

8. The method of claim 3, wherein the client comprises a client device, and wherein the analysis server determines a likelihood that the client device is controlled by a bot herder, and in response to determining a high likelihood that the client device is controlled by the bot herder, determining that the client device is not trustworthy.

9. The method of claim 1, wherein the client comprises a client device, the method further comprising:
if the advertisement is received at the proxy, inserting at the proxy a fraud detection program into the advertisement, wherein the fraud detection program, when executed by a processor at the client device, causes the client device to report to the proxy one or more of (i) whether the advertisement was displayed on the client device, (ii) how the advertisement was displayed on the client device, (iii) whether a user of the client device interacted with the advertisement, (iv) where the advertisement was displayed, and (v) whether any advertisements not from the ad server were displayed on the client device.

10. The method of claim 9, further comprising:
if the advertisement is received at the proxy, further inserting at the proxy a signature into the advertisement, the signature allowing the fraud detection program to determine whether an advertisement originated from the ad server or from a source other than the ad server.

11. The method of claim 9, further comprising:
based on information reported by the fraud detection program, determining by the proxy whether an impression should be recorded in association with the advertisement; and
if an impression should be recorded in association with the advertisement, notifying the ad server that an impression should be recorded in association with the advertisement.

12. The method of claim 9, wherein information collected by the fraud detection program is forwarded to an analysis server in order for the analysis server to determine whether the client device is trustworthy, and the ad server's determination of whether the client device is trustworthy is based on the analysis server's determination of whether the client device is trustworthy.

13. The method of claim 1, wherein the client comprises a client device, the method further comprising:
if the advertisement is received at the proxy, inserting at the proxy a fraud prevention program into the advertisement, wherein the fraud prevention program, when executed by a processor at the client device, causes any requests for advertisements from the client device to the ad server to be blocked.

14. The method of claim 2, wherein the client comprises a client device, the method further comprising:
receiving by the proxy behavioral information about a user of the client device, the behavioral information received from a subscriber database of the first ISP network; and
translating by the proxy the behavioral information into a video ad serving template (VAST) cookie, wherein the third request to the ad server further includes the VAST cookie.

15. The method of claim 1, wherein the client comprises a client device, and wherein the content received from the content provider comprises a mezzanine file, the method further comprising:
after the advertisement has been inserted into the mezzanine file, transmuxing the mezzanine file with the advertisement inserted therein into a format that is playable by the client device.

16. The method of claim 1, wherein the client comprises a client device, and wherein the content received from the content provider comprises an MPEG-4 fragment file, the method further comprising:
after the advertisement has been inserted into the MPEG-4 fragment file, transmuxing the MPEG-4 fragment file with the advertisement inserted therein into a format that is playable by the client device.

17. The method of claim 1, wherein the client comprises one or more of a client device and a user of the client device, and wherein the client identifier is one or more of an Internet protocol (IP) address of the client device, a hardware identifier of the client device, a media access control (MAC) address of the client device, a user name of the user, and a password of the user.

18. The method of claim 3, wherein data is periodically collected by the analysis server, and the analysis server uses this data to incrementally improve an accuracy of an assessment of the trustworthiness of the client.

19. A proxy communicatively coupled to a client, an ad server and a content provider, the proxy including instructions that, when executed by a processor of the proxy, cause the proxy to:
receive a first request from the client for content from the content provider;
in response to receiving the first request, transmit a second request to the content provider, the second request requesting the content on behalf of the client;
receive the content from the content provider, the content comprising an ad tag that provides specifications for an advertisement to be inserted into the content;
in response to detecting the ad tag, transmit a third request to the ad server for the advertisement to be inserted into the content, the third request including at least an identifier of the client;
if the ad server determines based on the client identifier that the client is trustworthy, (i) receive the advertisement from the ad server, (ii) insert the advertisement into the content, and (iii) transmit to the client the content with the advertisement inserted therein, the advertisement inserted in accordance with the ad tag; and
if the ad server determines based on the client identifier that the client is not trustworthy, (i) not receive the advertisement from the ad server and (ii) transmit to the client the content, but without the advertisement specified by the ad tag.

20. A non-transitory machine-readable storage medium for a proxy communicatively coupled to a client, an ad server and a content provider, the non-transitory machine-readable storage medium including instructions that, when executed by a processor of the proxy, cause the proxy to:
receive a first request from the client for content from the content provider;
in response to receiving the first request, transmit a second request to the content provider, the second request requesting the content on behalf of the client;
receive the content from the content provider, the content comprising an ad tag that provides specifications for an advertisement to be inserted into the content;
in response to detecting the ad tag, transmit a third request to the ad server for the advertisement to be inserted into the content, the third request including at least an identifier of the client;
if the ad server determines based on the client identifier that the client is trustworthy, (i) receive the advertisement from the ad server, (ii) insert the advertisement into the content, and (iii) transmit to the client the content with the advertisement inserted therein, the advertisement inserted in accordance with the ad tag; and
if the ad server determines based on the client identifier that the client is not trustworthy, (i) not receive the advertisement from the ad server and (ii) transmit to the client the content, but without the advertisement specified by the ad tag.
